(19) United States
(12) Patent Application Publication
(10) Pub. No.: US 2011/0003145 A1
(43) Pub. Date: Jan. 6, 2011

(54) METALLIZED COIL BODIES (INDUCTOR) HAVING HIGH Q-VALUE

(76) Inventor: Klaus Herrmann, Thiersheim (DE)

Correspondence Address: FULBRIGHT & JAWORSKI, LLP, 666 FIFTH AVE, NEW YORK, NY, 10103-3198, US

(21) Appl. No.: 12/920,123

(22) PCT Filed: Mar. 6, 2009
(86) PCT No.: PCT/EP2009/052655

§ 371 Date: Aug. 30, 2010

(30) Foreign Application Priority Data
Mar. 6, 2008 (DE) 10 2008 000 542.8
Mar. 7, 2008 (DE) 10 2008 000 557.6

(51) Int. Cl. B32B 5/00; B32B 18/00

(52) U.S. Cl. 428/332; 428/457; 428/469

(57) ABSTRACT

The invention relates to a body made of ceramic materials, having a basic metallization made of at least one electrically conductive material, such as tungsten/glass or molybdenum/glass compounds and an adhesive, electrically conductive and corrosion-resistant coating. In order to improve energy losses, which is to say to increase the Q-factor, it is proposed that the coating comprises/carries at least one functional layer made of a metal or several metals, having lower specific electrical resistance than the electrically conductive material and the remaining constituents of the coating.

The invention relates to a body consisting of ceramic substances with a base metallization consisting of at least one electrically conductive material, such as tungsten-glass or molybdenum-glass compounds, for example, and an adhesive, electrically conductive and corrosion-resistant coating.

Such bodies often comprise diamagnetic, oxidic substances and are generally provided with a base metallization or metallization in the form of a layer of tungsten-glass or molybdenum-glass compounds which is 3-15 μm thick, and this layer is then coated with a layer, which can be soldered, of nickel or nickel-gold of approximately 1-5 μm.

One disadvantage with this is that severe energy losses occur.

The frequency-dependent resistance to damping losses of an oscillating system is evaluated by Q=1/R*\sqrt{L/C}, where
Q=quality factor, also generally referred to as Q factor
R=total resistance
L=inductance
C=capacitance

High Q factors generally mean low energy losses. At a relatively low frequency-dependent total resistance R (includes ohmic resistance, transfer resistances, parasitic capacitances), the Q factor can be increased in order to arrive at fewer energy losses. This is technically desirable.

The invention is based on the object of improving a body in accordance with the preamble of claim 1 as regards energy losses, i.e. increasing the Q factor, and specifying a method for producing such a body.

This object is achieved according to the invention by the features of claim 1.

By virtue of the fact that the coating contains/has at least one functional layer consisting of a metal and/or a plurality of metals with an electrical resistivity which is lower than that of the electrically conductive material and the remaining constituents of the coating, the total electrical resistance of the metallization is reduced, the Q factor of the body.

In one embodiment, the coating comprises at least two layers. This depends on the requirements placed upon the body.

Preferably, the base metallization contains at least one refractory metal, for example tungsten and molybdenum.

Refractory metals are high-melting-point base metals of transition group 4 (titanium, zirconium and hafnium), transition group 5 (vanadium, niobium and tantalum) and transition group 6 (chromium, molybdenum and tungsten). Their melting point is above that of platinum (1772° C.)

Refractory metals are relatively corrosion-resistant at room temperature as a result of passivation. Advantageous factors are not only the high melting point of the refractory metals, but also the low coefficient of thermal expansion and the high conductivity, compared with steel, for heat and electrical current.

In an embodiment according to the invention, the base metallization comprises tungsten-glass or molybdenum-glass compounds.

Preferably, the coating comprises a nickel and/or a gold layer.

In a configuration according to the invention, at least one functional layer is arranged between the layers of the coating. The function of the functional layer can be divided between different layers; only the combined effect of all of the functional layers is important.

Preferably, the nickel layer contained in the coating has a thickness of 0.5-2 μm.

Preferably, the nickel layer contained in the coating has a resistivity of from 4 to 10*10⁻⁸ ohm*m, preferably 7*10⁻⁸ ohm*m.

A preferred embodiment is characterized in that the functional layer consisting of a metal with a low electrical resistivity is a copper layer.

In a configuration according to the invention, the copper layer has a thickness of 1-10 μm.

Preferably, the copper layer has a resistivity of 1.0 to 2.6*10⁻⁸ ohm*m, preferably 1.8*10⁻⁸ ohm*m.

Preferably, the ceramic substance is aluminum oxide, preferably 96% aluminum oxide.

In a specific embodiment, the base metallization is dispensed with and the coating performs the function thereof.

Preferred is the use of the body as a coil former or inductor.

The text which follows describes a preferred embodiment and a method for the manufacture thereof, in which the body is a coil former consisting of diamagnetic, oxidic substances with a base metallization consisting of tungsten-glass or molybdenum-glass compounds and a coating consisting of a nickel layer and a gold layer. According to the invention, at least one further layer, i.e. a functional layer consisting of a metal with a low electrical resistivity, is also applied between the nickel layer and the gold layer.

By virtue of this further layer (functional layer) with a low electrical resistivity, the total electrical resistance of the metallization is reduced and the Q factor of the coil former or the entire circuit with the wire coil is increased.

The nickel layer has a thickness of 0.5-2 μm and/or a resistivity of from 4 to 10*10⁻⁸ ohm*m, particularly preferably 7*10⁻⁸ ohm*m.

In this embodiment, the further layer (functional layer) is a copper layer with a layer thickness of 1-10 μm and/or a resistivity of 1.0 to 2.6*10⁻⁸ ohm*m, preferably 1.8*10⁻⁸ ohm*m.

In this configuration, the diamagnetic, oxidic substance is aluminum oxide, preferably 96% aluminum oxide.

A method for manufacturing such a coil former from diamagnetic, oxidic substances, wherein the coil former is coated with a tungsten-glass metallization and this metallization is baked, is coated with a nickel layer and a gold layer is deposited thereon, is characterized by the fact that first at least one further layer consisting of a metal with a low electrical resistivity is applied to the nickel layer and only then is the gold layer deposited.

The nickel layer is preferably cathodically copper-plated.

In a development according to the invention, the nickel layer is cathodically copper-plated up to a thickness of from 1 to 10 μm.

The diamagnetic, oxidic substance used is preferably aluminum oxide, particularly preferably 96% aluminum oxide.

After the base metallization with tungsten-glass or molybdenum-glass or glass compounds, as described, first a thin nickel layer (preferably with a resistivity of 7*10⁻⁸ ohm*m) of 0.5-2 μm is applied.

Then, according to the invention, at least one layer (functional layer) consisting of a metal with a low electrical resistivity is also applied so as to improve the Q factor. In a configuration according to the invention, this layer comprises a copper layer (preferably with 1.8*10⁻⁸ ohm*m) with a thickness of 1-10 μm.

As a result of this, the total resistance of the metallization is reduced, and the Q factor of the coil former or the total circuit with the wire coil is increased.

A preferred configuration according to the invention of the coil former will be compared with a comparative example below.

### 1. EXAMPLE ACCORDING TO THE INVENTION

In a U-shaped coil former of the type 0805 (in accordance with American EIA standards), which, after winding of the wire, is soldered with feet onto printed circuit boards and comprises 96% Al₂O₃ (aluminum oxide), the two feet were coated with a tungsten-glass metallization, and this metallization was baked at 1300° C. in a humid protective gas atmosphere. Then, this tungsten-glass metallization or base metallization was coated, in electroless fashion, with a thin nickel layer of 0.5 μm thickness in a rotary drum with an internal diameter of 200 mm, filled with 60 000 parts. Then, the parts were cathodically copper-plated together with metal wire sections in another rotary drum. The copper layer measured up to 10 μm. Then, a gold layer with a thickness of 0.1 μm was deposited in electroless fashion. The Q factor was measured at 1.35 GHz and an inductance of 39 nH and was 80-90.

### 2. COMPARATIVE EXAMPLE

In a U-shaped coil former of the type 0805 (in accordance with American EIA standards), which, after winding of the wire, is soldered with feet onto printed circuit boards and comprises 96% Al₂O₃ (aluminum oxide), the two feet were coated with a tungsten-glass metallization, and this metallization was baked at 1300° C. in a humid protective gas atmosphere. Then, this tungsten-glass metallization or base metallization was coated, in electroless fashion, with a thin nickel layer of 2.5-3.0 μm thickness in a rotary drum with an internal diameter of 200 mm, filled with 60 000 parts. Then, a gold layer with a thickness of 0.1 μm was deposited in electroless fashion. The Q factor was measured at 1.35 GHz and an inductance of 39 nH and was 62-75.

It is apparent from this that the Q factor is increased by virtue of the method according to the invention (see number 1). In the example mentioned, there was an increase in the Q factor of from 62-75 (comparative example) to 80-90 (example according to the invention).

1-14. (canceled)

15. A body comprising a ceramic substances with a base metallization consisting of at least one electrically conductive material, such as tungsten-glass or molybdenum-glass compounds, for example, and an adhesive, electrically conductive and corrosion-resistant coating, wherein the coating comprises at least one functional layer consisting of a metal or a plurality of metals with an electrical resistivity which is lower than that of the electrically conductive material and the remaining constituents of the coating.

16. The body as claimed in claim 15, wherein the coating comprises at least two layers.

17. The body as claimed in claim 15, wherein the base metallization contains at least one refractory metal.

18. The body as claimed in claim 15, wherein the base metallization comprises tungsten-glass or molybdenum-glass compounds.

19. The body as claimed in claim 15, wherein the coating comprises a nickel and a gold layer.

20. The body as claimed in claim 15, wherein at least one functional layer is arranged between the layers of the coating.

21. The body as claimed claim 15, wherein the nickel layer contained in the coating has a thickness of 0.5-2 μm.

22. The body as claimed in claim 15, wherein the nickel layer contained in the coating has a resistivity of from 4 to 10*10⁻⁸ ohm*m.

23. The body as claimed in claim 15, wherein the functional layer consisting of a metal with a low electrical resistivity is a copper layer.

24. The body as claimed in claim 23, wherein the copper layer has a thickness of from 1-10 μm.

25. The body as claimed in claim 23, wherein the copper layer has a resistivity of from 1.0 to 2.6*10⁻⁸ ohm*m.

26. The body as claimed in claim 15, wherein the ceramic substance comprises aluminum oxide.

27. The body as claimed in claim 15, wherein the base metallization is dispensed with and the coating performs the function thereof.

28. A coil former or inductor comprising a body as claimed in claim 15.

29. The body as claimed in claim 15, wherein the base metallization comprises at least one of tungsten or molybdenum.

30. The body as claimed in claim 15, wherein the nickel layer contained in the coating has a resistivity of from 7*10⁻⁸ ohm*m.

25. The body as claimed in claim 23, wherein the copper layer has a resistivity of from 1.8*10⁻⁸ ohm*m.

26. The body as claimed in claim 15, wherein the ceramic substance comprises 96% aluminum oxide.
